(19) United States
(12) Patent Application Publication
(10) Pub. No.: US 2025/0320980 A1
(43) Pub. Date: Oct. 16, 2025

(54) LED Light Engine

(71) Applicant: Morten Hjerde, Vinterbro (NO)

(72) Inventor: Morten Hjerde, Vinterbro (NO)

(21) Appl. No.: 19/177,251

(22) Filed: Apr. 11, 2025

Related U.S. Application Data
(60) Provisional application No. 63/632,863, filed on Apr. 11, 2024.

(51) Int. Cl. F21V 13/04; F21V 5/00; F21V 17/10; F21Y 113/13; F21Y 115/10

(52) U.S. Cl. CPC F21V 13/04; F21V 5/004; F21V 17/105; F21Y 2113/13; F21Y 2115/10

(57) ABSTRACT

An LED light engine that produces homogeneous light that may efficiently concentrated to a required degree of divergence is disclosed. In a preferred embodiment, a narrow beam angle LED light engine has a homogenous light field produced by of light emitting surface consisting of an array of LEDs and homogenized by a light mixer. A concentrating mirror further reduces the divergence of the light field. The light mixer is a pillow lens/micro lens light mixer. The light mixer has a magnetic mount attached to it, allowing it to be removably attached to a mounting pillar that includes a rare-earth magnet. In one embodiment, the light emitting surface is an RGBACL COB.

### CROSS-REFERENCE TO RELATED APPLICATIONS

This application claims priority to U.S. provisional patent application U.S. 63/632,863 filed on Apr. 11, 2024 entitled “LED Grow Light Assembly and Engine” the contents of which are hereby fully incorporated by reference.

### BACKGROUND OF THE INVENTION

The invention relates to systems and methods for producing high quality, temperature adjustable white light, and more particularly to using assemblies of semiconductor light emitting diodes (LEDs) to produce that white light, and most particularly to using combinations of six different colors of LED to efficiently produce the high quality, temperature adjustable white light.

LED lighting has the advantages of being long lasting, energy efficient and producing less heat. LEDs are easily controlled, versatile and produce directed light which makes them particularly useful for spotlighting and accent lighting. However, because of the narrow spectral range of the individual LEDs, unless carefully selected and combined, they may produce less accurate color rendering than traditional incandescent and fluorescent lighting. Recent advances in LED technology have resulted in phosphor-converted devices that are both more efficient and produce a wider range of colors than conventional direct drive LEDs.

In particular, surface mounted LEDs on aluminum printed circuit boards have become an efficient and effective way to produce light sources. However, their output lacks the homogeneity that may be required for various studio lighting tasks and tends to be more divergent than what may be optimal. What is required are LED light engines that produce homogeneous light that is efficiently concentrated to a required degree of divergence.

Relevant prior art includes:

U.S. Pat. No. 9,560,714 issued to M. Hjerde on Jan. 31, 2017 entitled “Color Temperature Adjustable, LED Based, White Light Source”, the contents of which are hereby incorporated by reference in their entirety.

That patent describes assemblies of temperature monitored, semiconductor light emitting diodes (LEDs) that produce color temperature adjustable white light sources. Warm-white LEDs are combined with green and blue LEDs to produce light have continuous spectrum spanning the wavelength range of 400 to 700 nm with a white light point located at a selectable Planckian locus location and a color rendering index greater than 80. The circuitry includes LED temperature monitoring used to adjust LEDs spectral and luminosity output.

US 2024/0349406 by applicant M. Hjerde entitled “System and Method for Producing High Quality Temperature Adjustable White Light” published on 17 Oct. 2024, the contents of which are hereby incorporated by reference in their entirety.

The publication describes systems and methods of producing high quality temperature adjustable white light using six different colored LEDs is disclosed. In one embodiment the six LEDs are a Red (630 nm), an Amber (589 nm), a lime LED (568 nm), a green LED (540 nm) a cyan LED (505 nm) and a blue (430 nm). Optimal relative intensities of the RGBACL LED are calculated by solving a matrix relating the CIE tristimulus values. Alternatively, optimum relative intensities may be calculated for two light sources lying on a line of constant CCT value, but on opposite sides of the Planckian locus. These relative intensities for each of the light sources are then retained and adjusted as a group to obtain a single white light source of the requested CCT value lying on the Planckian locus.

Various implementations are known in the art, but fail to address all of the problems solved by the invention described herein. Various embodiments of this invention are illustrated in the accompanying drawings and will be described in more detail below.

### SUMMARY OF THE INVENTION

An LED light engine that produces homogeneous light that may efficiently concentrated to a required degree of divergence is disclosed.

In a preferred embodiment, a narrow beam angle LED light engine having an homogenous light field may consist of light emitting surface comprised of an array of LEDs, a light mixer, and a concentrating mirror.

The light mixer may consist of a pillow lens/micro lens light mixer. The light mixer may have magnetic mount attached to it so that it may be attached to a mounting pillar that may contain a magnet that may be rare-earth magnet.

In one embodiment of the invention, the light emitting surface may be an RGBACL COB.

### BRIEF DESCRIPTION OF DRAWINGS

FIG. 1 shows schematic cross-sectional view of an assembled LED light engine of the present invention.

FIG. 2 shows a schematic perspective view of a mounted pillow lens/micro lens light mixer of the present invention.

FIG. 3 shows a schematic perspective view of a pillow lens/micro lens light mixer.

FIG. 4 shows a schematic view of an array of pillow lens/micro lens light mixers and diffusers.

FIG. 5 shows a schematic cross-sectional view of an LED light engine of the present invention.

FIG. 6 shows a schematic cross-sectional view of an RGBACL COB of the present invention.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

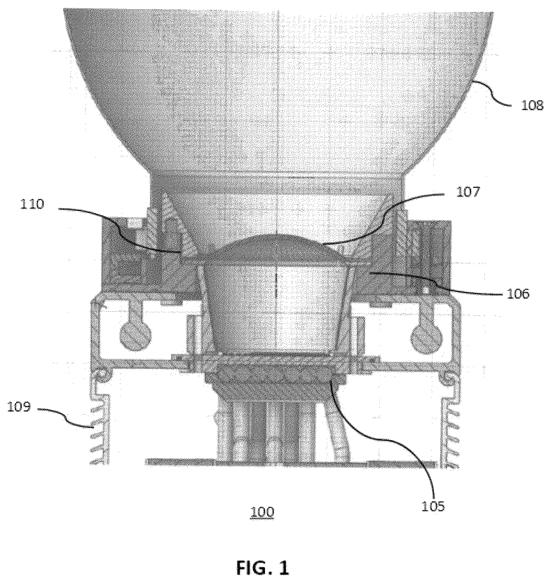

FIG. 1 shows schematic cross-sectional view 100 of an assembled LED light engine of the present invention.

As shown, the assembled LED light engine may have a LED array 105. This may, for instance, be a flat aluminum printed circuit board (PCB) that may be populated with at least two variants of LEDs. The LED array may, for instance, be an RGBACL LED light engine as described in for instance published patent application US 2024/0349406 entitled “System and Method for Producing High Quality Temperature Adjustable White Light” published on 17 Oct. 2024.

The emitted light may pass through a pillow lens/micro lens light mixer 107. The pillow lens or micro lens light mixer may be an optical component used to homogenize and shape light output. It may, for instance, be consist of an array of small, convex (or double convex) pillow-shaped, microlenses arranged to blend and smooth out the light distribution. The pillow lens/micro lens light mixer may help mix light from different sources, such as multi-color LEDs, and may achieve uniform color blending. It may also reduce hot spots and create a more uniform illumination across a target area. Because of its compact design it may achieve high performance in a small form factor, making it useful in applications where space is limited.

The LED light engine may also include a concentrating mirror 108. This mirror may, for instance, have a shape designed to help direct light in a specific pattern, such as, but not limited to, a portion of a conic section, thereby improving optical efficiency and further reducing the divergence of the beam.

LED light engine may also include a magnetic mount 110. This may allow for quick and easy changing of different pillow lens/micro lens light mixers or related diffusers.

FIG. 2 shows a schematic perspective view 200 of a mounted pillow lens/micro lens light mixer of the present invention.

The pillow lens/micro lens light mixer 107 may have a magnetic mounting ring 205. This may, for instance, be made of a ferromagnetic materials, such as, but not limited to, stainless steel, iron or an alloy of iron containing, for instance, nickel cobalt.

The pillow lens/micro lens light mixer may be attached to a base platform 206 by a mounting pillar 207. The mounting pillar may contain a magnet (not shown) that may, for instance, be a rare earth magnet such as, but not limited to, a Neodymium-Iron-Boron (NdFeB) magnet or a Samarium-Cobalt (SmCo) magnet. The later is less powerful than neodymium but highly resistant to corrosion and high temperatures, up to 300° C.

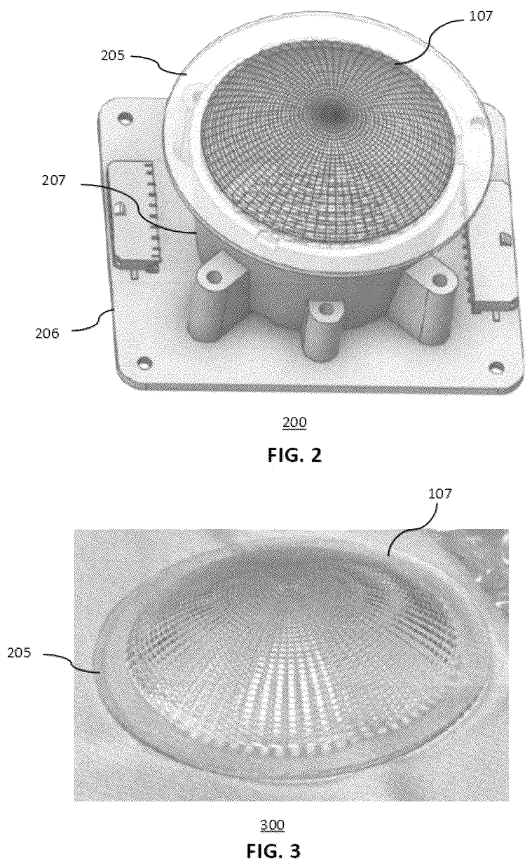

FIG. 3 shows a schematic perspective view 300 of a pillow lens/micro lens light mixer 107. As shown, the pillow lens/micro lens light mixer may have a magnetic mounting ring 205 that may be made of a suitable ferromagnetic material.

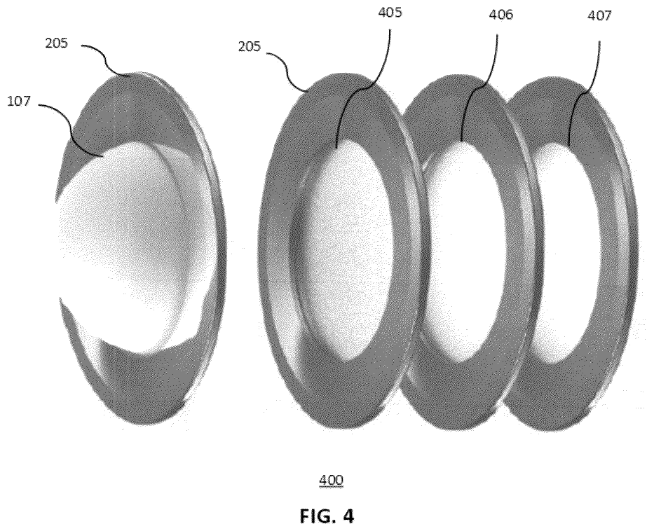

FIG. 4 shows a schematic view 400 of an array of pillow lens/micro lens light mixers and diffusers. The pillow lens/micro lens light mixer 107 may have a magnetic mounting ring 205. Similarly, each of the diffusers 405, 406 and 407 may have their own magnetic mounting ring 205. Each of the diffusers may have different optical properties including transmission efficiency and uniformity of the transmitted light.

FIG. 5 shows a schematic cross-sectional view 500 of an LED light engine of the present invention.

The LED light engine may have a LED array 509 on emitter board. Light emitted form the LED array may be directed forward by an internal reflector reflective surface 507 that may guide light forward from the source. The pillow lens/micro lens light mixer 508 may be removably attached by means of a magnetic mount 506. The magnetic mount 506 may include a rare earth magnet such as, but not limited to, a Neodymium-Iron-Boron (NdFeB) magnet or a Samarium-Cobalt (SmCo) magnet. The LED light engine may have a heat sink 510 as well as one or more cooling fans 511. There may also be an air ventilation grate 512 to allow for to flow into or out of the system.

The LED light engine may also include a Bowens mount 505 to allow easy attachment of devices such as, but not limited to, barn doors.

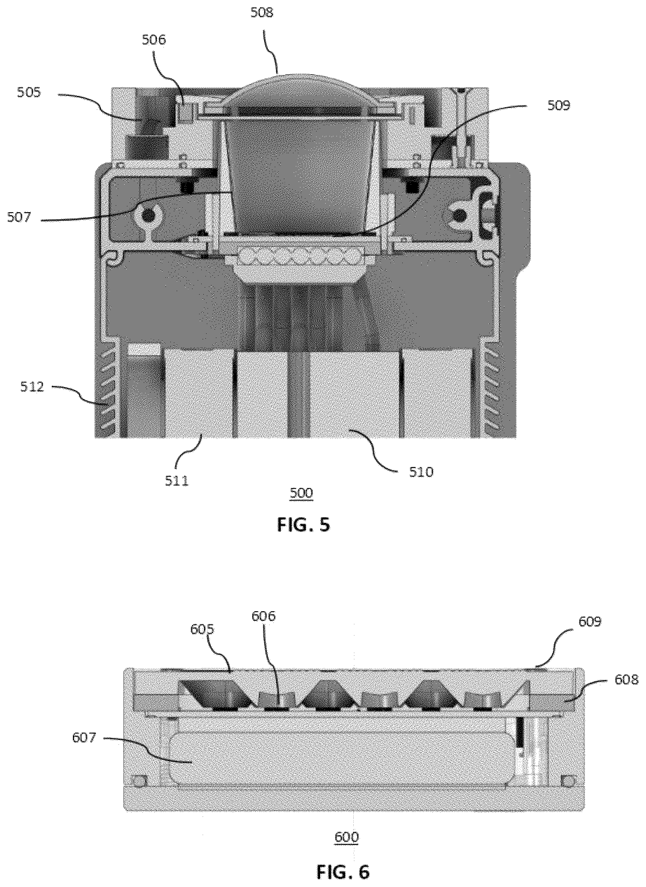

FIG. 6 shows a schematic cross-sectional view 600 of an RGBACL COB of the present invention.

The Red, Green, Blue, Amber, Cyan, Lime (RGBACL) chip on board (COB) may have multiple LED chips mounted directly onto a single substrate, creating a compact, high-intensity light source. The RGBWW LEDs may allow for a wider color gamut, including more saturated colors, like yellows and greens, and a broader correlated color temperature (CCT) range, typically from 2000K to 10000K. They may be useful for precise color mixing and produce a high Color Rendering Index (CRI) thereby providing more natural and vibrant lighting.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1: A narrow beam angle LED light engine having an homogenous light field, comprising:
A light emitting surface comprised of an array of LEDs;
a light mixer; and
a concentrating mirror.

2: The LED light engine of claim 1 wherein said light mixer comprises a pillow lens/micro lens light mixer.

3: The LED light engine of claim 2 further comprising a magnetic mount attached to said pillow lens/micro lens light mixer, and a magnet attached to a mounting pillar.

4: The LED light engine of claim 3 where said light emitting surface magnet is a rare-earth magnet.

5: The LED light engine of claim 3 wherein said light emitting surface is an RGBACL COB.
